(19) United States
(12) Patent Application Publication
(10) Pub. No.: US 2013/0110573 A1
(43) Pub. Date: May 2, 2013

(54) IDENTIFICATION AND OPTIMIZATION OF OVER-ENGINEERED COMPONENTS

(71) Applicants: Michael PYE, Anderson, NC (US); Ivo WILLEMS, Houston, TX (US)

(72) Inventors: Michael PYE, Anderson, NC (US); Ivo WILLEMS, Houston, TX (US)

(73) Assignee: FLUOR TECHNOLOGIES CORPORATION, Aliso Viejo, CA (US)

(21) Appl. No.: 13/287,802

(22) Filed: Nov. 2, 2011

(51) Int. Cl. G06Q 10/04; G06Q 10/06

(52) U.S. Cl. 705/7.23

(57) ABSTRACT

A capital project optimization tool is presented. Engineers can interact with the tool by submitting one or more capital project components to an optimization engine. A current component can be correlated with historical components to identify if similar historical components have been used in similar circumstances. If so the engine can determine if the similar historical components where over-engineered. Alternatives components can be found that would have a better satisfaction level for historical or current project requirements. The alternative components can also have a different level of estimated impact on one or more project metrics.

### FIELD OF THE INVENTION

The field of the invention is construction optimization technologies.

### BACKGROUND

When designing or engineering a new facility for construction, engineers often utilize known components in a design even when the known components exceed design requirements. One of the many reasons for such an activity includes expediting the design phase of the capital project. However, the known component unfortunately remains a committed part of the capital project even when the known component has undesirable impacts on project metrics, possibly affecting the entire capital project. For example, a component might exceed design requirements while requiring additional training or expertise during facility operation. Ideally, engineers would have an early phase solution in identifying over-engineered scenarios to ensure one or more project metrics remain uncompromised.

Others have encountered situations where over-engineering can be a problem. For example, U.S. Pat. No. 7,400,720 to Savor et al. titled “System and Method for Optimizing Digital Subscriber Line Based Services”, filed Oct. 5, 2004, describes deploying an over-engineered DSL line. The DSL line is brought on-line in an over-engineered state, and then later optimized to determine provisioning parameters. Unfortunately, applying such an approach to optimizing construction components is impracticable in a large scale capital project (e.g., power plan, nuclear plant, processing facility, etc.) where the component remains fixed through the life time of the facility.

U.S. Pat. No. 7,571,084 to Smith et al. titled “System and Method for Morphable Engineering Criteria”, filed Jul. 20, 2005, seeks to optimize the design of an automobile. Engineers can use a design tool to adjust design constraints according to constrain functions while maintaining design requirements. Although useful when optimizing a design that is intermediate between two designs, the disclosed approach fails to appreciate how an over-engineered component can impact project metrics.

U.S. patent application publication 2004/0073410 to Maly et al. titled “Computerized System and Method of Collaborative Structural Frame Development”, filed Oct. 15, 2002, describes a collaborative system allowing multiple building designers to work together on a design. The collaborators can work together to control various design parameters when optimizing a structural frame. Unfortunately, Maly also fails to provide insight into over-engineered components. In fact, Maly specifically points out that over-engineering produces inefficiencies. Clearly, Maly indicates a long felt need for identifying scenarios where a design has over-engineered features, but fails to address providing insight into how to identify instances of over-engineered components in a capital project. Thus, there is still a need for capital project optimization tools.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

### SUMMARY OF THE INVENTION

The inventive subject matter provides apparatus, systems and methods in which one can utilize a capital project optimization tool to identify areas of over-engineering. One aspect of the inventive subject matter includes a construction optimization tool comprising a project design interface, a project database, a component database, and an optimization engine. An engineer, or other user, interacts with the tool via the project design interface. In some embodiments, the design interface operates as a Computer Aided Design (CAD) system, or other project tool (e.g., SP3D, OptimEyes, etc.). The engineer submits one or more project component primitives in the form of component input to the system. Component input, or other project related data, can be stored in the project database, possibly in project agnostic format. Example types of data that can be stored within the project database include project metrics, component characteristics, environmental characteristics, or component requirements. The characteristics can be considered attributes associated with the components or with the environment in which the component is to be deployed. The project database can be implemented as a project-specific database as desired. The component database, which can be incorporated into the project database, can store historical information related to one or more previous projects where the historical information can include historical component or environment characteristics, or even historical requirement information.

As engineers interact with the tool, the optimization engine can seek out opportunities for optimizing the design. For example, as component input is accepted the engine can correlate the components with historical components used in similar scenarios in previous projects. If the similar historical components exceeded historical design requirements in its historical project, then it was likely over-engineered. The optimization engine can further search for alternative components that would have had a different level of satisfaction of the historical design requirement (e.g., greater level, reduced level, etc.) where the alternative component contributes to optimizing a project metric.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a capital project development environment having an optimization engine.

FIG. 2 presents an overview of a project database storing construction component objects, project metrics, and component requirements.

FIG. 3 presents an overview of a component database storing historical component objects and requirements.

FIG. 4 presents a possible method for identifying instances of over-engineering.

FIG. 5 presents a qualitative diagram illustrating the extent of a component's satisfaction of a set of requirements.

### DETAILED DESCRIPTION

It should be noted that while the following description is drawn to a computer/server based optimization tools, various alternative configurations are also deemed suitable and may employ various computing devices including servers, interfaces, systems, databases, agents, peers, engines, platforms, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including contributions to altering a physical capital project to ensure the physical construction comprises optimized features.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It has yet to be appreciated that an optimization tool can be constructed that allows engineers to identify when a desired construction component for a capital project is over-engineered, especially with respect to its intended environment in a current project. The component and its expected environment can be compared against historical components and historical projects to determine if alternative components could be utilized in the current project. If so, one or more alternative components might have a more preferred impact on a project metric.

In a capital project design engineer seeks previously used real-world construction components as a drop-in solution for a current project's component requirements. Although the drop-in solution is an expedient solution, the drop-in solution might be over-engineered and fail to optimize desirable project metrics beyond expediency of design. The design engineer would benefit from seeking alternative historical real-world components that are less over-engineered, and fit the current needs while also optimizing desirable project metrics. One should note that conducting an analysis around the over-engineered component as an analytical pivot point rather than a current project's component requirements gives rise to discovery of alternative's that an engineer would not ordinarily consider. Thus, based on submission of a construction component primitive, the optimization engine can determine possible optimized drop-in solutions that are not over-engineered.

Capital projects are considered to include large scale construction project. Example large scale projects include construction of nuclear power plants, bridges, processing facilities, chemical plants, oil refineries, or other large scale projects. Further, capital projects comprise multiple phases or stages over the life time of the project. Project phases can include proposal, planning, engineering, design, procurement, construction, operation, management, end-of-life, or other phases.

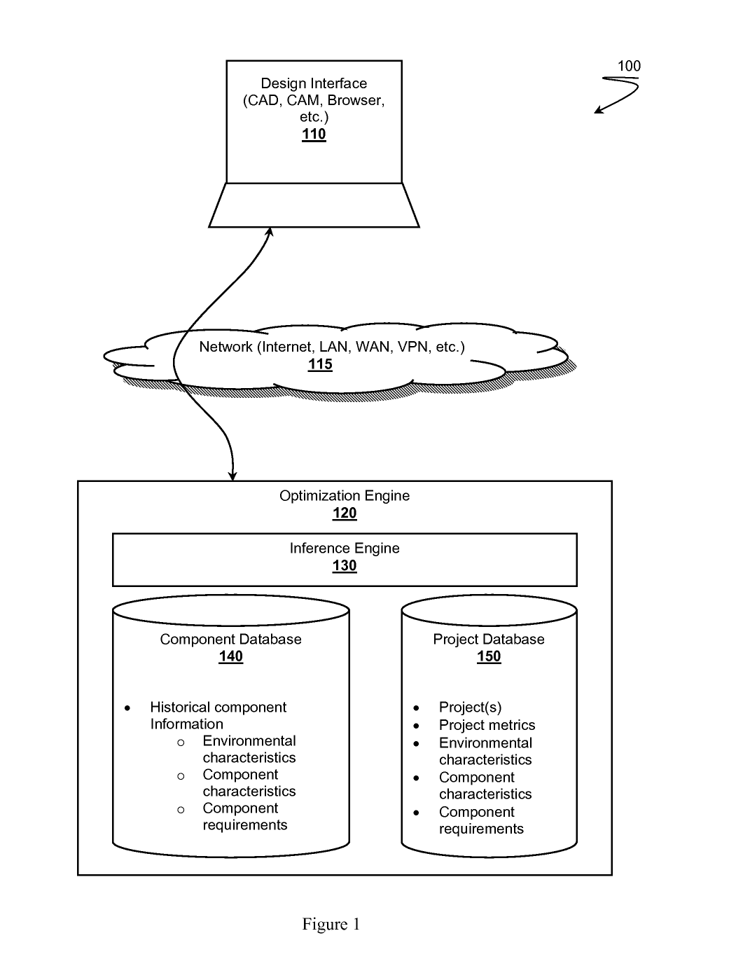

In FIG. 1 capital project design environment 100 includes optimization engine 120, which is capable of identifying instances of over-engineering in historical projects and leveraging such information for use in a current project. In the example shown, engineering construction optimization engine 120 interfaces with project design interface 110 over network 115. Optimization engine 120 can also couple with component database 140 storing historical component information, project database 150 storing project specific information, and inference engine 130. One should note that other configurations of optimization environment 100 are possible beyond those shown in the example. For example, component database 140 or project database 150 could be external to optimization engine 120 or located remotely over network 115.

An engineer interfaces to the optimization environment 100 through project design interface 110 and provides design information to optimization engine 120. The design information preferably comprises component input reflecting one or more parameters, values, properties, attributes, or characteristics representative of a construction component to be incorporated into a current capital project or its design. The component input preferably comprises a construct component object representing a design object primitive lacking correspondence with a physical real-world construction component. In some embodiments, project design interface 110 can comprise one or more computer aided design (CAD) tools suitably adapted to communicate with other components of optimization environment 100, possibly over network 115 as shown. Example project design interfaces 110 can be based on SP3D®, SmartPlant®, Galaxy™, OptimEyes™, Smap3D™, PDMS™, Autodesk® Plant Design Suite, or other construction related design tools. It is also contemplated the project design interface can be presented in the form of a web interface through which the engineer submits project or component information.

As an engineer interacts with project design interface 110, generated component input can be stored within project database 150. Project database 150 euphuistically represents information related to the current project under design. Although only one project database 150 is illustrated one should appreciate that optimization environment 100 could include multiple project databases 150, possibly one database for each project. Further, project database 150 could store more than one current project or could also be combined component database 140 storing historical information. Project database 150 stores various data objects preferably in a project agnostic manner. The data objects (e.g., component objects, metrics, requirements, etc.) can also be assign attributes or values according to a common namespace through which various objects can be compared or correlated with each other. In some embodiments, the common namespace adheres to one or more ontologies. Example namespaces can include hierarchical namespaces, well defined taxonomies, or other normalized naming conventions. Example data stored within the project database include project metrics, component characteristics, environmental characteristics, or component requirements associated with the capital project.

Inference engine 130 employs one or more algorithms to establish correlations between construction components in project database 150 of a current capital project and historical construction components in component database 140. Once correlations have been established, to within desirable thresholds or criteria, inference engine 130 can compare and contrast the use of historical construction components in historical projects to determine if such historical construction components could be used in the current project. Further, historical construction components can be analyzed to determine if they exceeded historical requirements, thus indicating they were over-engineered, possibly due to expediency.

Inference engine 130 can determine correlations among construction component primitive and historical components via many different techniques. In some embodiments, inference engine 130 compares characteristics of one object to the characteristics of other objects to determine if they are related. For example, a current construction component object might have numerous characteristics (e.g., attributers, parameter—value pairs, data structures, etc.) outlining the properties of the component object with respect to a current project: dimensions, size, name, identifiers, functional roll, behaviors, contexts for which the component is relevance, etc. Inference engine 130 searches component database 140 for historical component objects having matching characteristics, or similar within defined satisfaction criteria. Such an approach is very straight forward. In other embodiments, inference engine 130 can employ more elaborate techniques to establish correlations among the various data objects including case-based reasoning, logical reasoning (e.g., inference, abductive, deductive, etc.), AI techniques (e.g., neural networks, genetic algorithms, etc.).

In some embodiments, optimization engine 120, possibly via inference engine 130, can utilize the various reasoning methods to infer correlations the component or environment characteristics with the project metrics. Such an approach allows for determining which real-world historical components had the most desirable impact project metrics. For example, a project metric could include a final state of a construction project (e.g., end state of design or construction phase, end of life, etc.). In such scenarios, optimization engine 120 can generate recommendations of historical components that more closely align with a final state determined from a backward chaining analysis. A discussion regarding backward chaining analysis, case-based reasoning, forward chaining analysis, and other reasoning methods can be found in co-owned U.S. patent application Ser. No. 13/233,311 entitled “Intelligent Plant Development Library Environment”, filed on Sep. 15, 2011.

Optimization engine 120 can be further configured to incorporate self-learning aspects. Consider a scenario where optimization engine 120 provides recommended alternative historical components to design engineers while the design engineers consistently select a different component other than the recommended alternatives. Optimization engine 120, possibly via inference engine 130, can analyze the selected components to determine if there are correlations among the selected components characteristics (e.g., component characteristics, environmental characteristics, contexts, etc.) using the techniques described above. If correlations are found, then optimization engine 120 can incorporate the correlations into the weighting or prioritization of future recommendations. In some embodiments, a correlation might be found between the selected components and project characteristics, but no correlation is found with a known project metric. In such a scenario, optimization engine 120 can query the design to engineer via design interface 110 for additional metric definitions to be associated with the selected component. Thus, optimization engine 120 continues to learn and incorporate newly derived information into its recommendations.

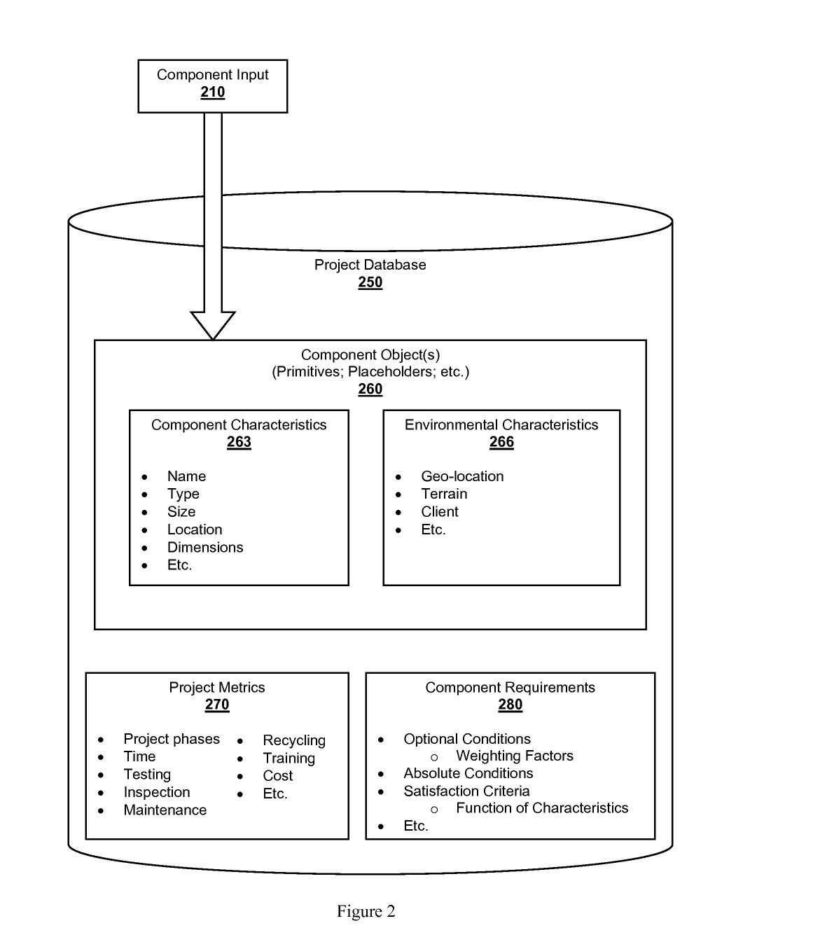

FIG. 2 provides a more detailed view of a project database 250. Component input 210 is provided to the system, which in turn stores the component input as data objects, preferably at least as construction component primitives lacking correspondence to a physical real-world construction component. Data objects, component object 260 for example, can be stored using XML or other suitable data format where the characteristics of component object 260 can be stored as tags along with specific values for the tags representing a construction component primitive. The object characteristics can also conform to a common normalized namespace allowing each object to be easily correlated with other objects as desired. For example, a component can include characteristics outlining its proper use. Such use characteristics can be correlated with environmental characteristics 266 for a specific capital project, thus the optimization engine is able to determine if one object is similar to or compatible with other objects. All possible normalized namespaces are contemplated.

Two preferred types of characteristic include component characteristics 263 and environmental characteristics 266. Component characteristics 263 represent required attributes describing the specified component features in a project as represented by component object 260. Example characteristics could include a name, a specific location or orientation, a size, a dimension, a functional capability, a flow rate, context, a pressure rating, or other information specifically related to the current construction component. Environmental characteristics 266 represent project related information as it pertains, possibly indirectly, to the current construction component. Example environmental characteristics could include geo-location, terrain type, client information, vendor information, firm information, project phase information, time of year, or other attributes describing a project environment in which the construction component is intended to be disposed. Although environmental characteristics 266 are illustrated as within component object 260, one should appreciate environmental characteristics 266 could be stored as a separate object, possibly pertaining to the project in general. Some of environmental characteristics 266 bound to data objects at different levels in an inherited hierarchy. For example, environmental characteristics 266 and be bound to the component object 260, groups of component objects 260, system level objects, project phase level objects, or other levels. Thus, one component object 260 could link to multiple sets of environmental characteristics 266 at different hierarchical levels associated with the capital project. Environmental characteristics 266 can be used by the inference engine, among other information, to determine a context for which component object 260 is intended thereby allowing the inference engine to determine if historical construction components could be leveraged for use.

Project database 250 can also store one or more data objects representative of project metrics 270. Project metrics 270 cover a broad spectrum of measurable parameters that can impact optimization at many different levels in the capital project. Project metrics 270 can have a fine level of granularity at the component level up through the system or even project level. Further, project metrics 270 can include tangible metric or intangible metrics. Tangible metrics represent metrics capable of being directly measured or quantified (e.g., cost, time, weight, personnel, etc.), while intangible metrics represent subjective measurements. Example intangible metrics can include opinion data (e.g., surveys, buzz, etc.), or political clout. It is specifically contemplated that an estimated impact on an intangible metric by a construction component can be considered to outweigh impacts on tangible metrics. For example, sourcing the construction component from one vendor at additional cost could impact local acceptance of the capital project by creating jobs. Thus a physical real-world component under consideration might be considered more optimal than recommended alternative components. Example project metrics can include costs, time, maintenance costs, inspection times, ease of use, training, personnel, destruction or end-of-life metrics, support from a jurisdiction, a cost metric, a vendor metric, a space metric, a client metric, a buzz metric, or other types of metric.

Project metrics 270 can also be prioritized relative to each other with respect to the capital project. For example, one project metric could be more critical to a design than a second project metric. Thus, project metrics 270 can comprise a prioritized set of metrics. The prioritized set of metrics aid a designer when determining which alternative components would be most suitable in a design by allowing the designer observe how each alternative components impacts the prioritized metrics. Consider a scenario where public perception of the capital project is prioritized over cost of materials. One locally produced physical component could impact a public perception metric than another component having reduced costs, but produced remotely. When recommended alternative components are presented to a design engineer, they can be presented in ranked listing according to one, two, or more of the prioritized metrics.

Consider an example where a physical real-world component comprises a processing block module as discussed in co-owned U.S. patent application publication 2011/0146164 titled “Modular Processing Facility”, filed Dec. 17, 2011. A processing block module could represent an alternative component to an over-engineered component that might have a reduced level of satisfaction relative to the over-engineered component, but further optimizes a project metric related to modularization. For example, a project metric can include modularization metric, which reflects how modular a capital project is. Such a metric is useful when the capital project requires remote assembly of modules due to inhospitable locations that prevent local construction (e.g., frozen tundra, remote locations, deserts, etc.).

Project database 250 can also store one or more component requirements 280, which represent a project's criteria for a physical component's desired role within the project. Requirements 280 can also take on my different forms. Requirements 280 can include absolute requirements or conditions, optional conditions, weighting factors, satisfaction criteria, functional or behavior rules, or other information. In some embodiments, a measure of satisfaction of the requirements can be derived based on the level of which a physical construction component satisfies the requirements. For example, requirements 280 can include satisfaction criteria based on, or as a function of component characteristics 263 where the satisfaction criteria can be used to measure a level of satisfaction, possibly based on a numerical analysis. Requirements 280 can further include those provided by the construction firm, a client, or even a jurisdiction (e.g., country, region, state, county, city, etc.) governing body.

When a physical component corresponding to component object 260 overly satisfies the satisfaction criteria of component requirements 280, the physical component can be considered to be over-engineered with respect to the requirements. For example, pump valve might support 10,000 PSI while requirements 280 dictate a required support level of only 8,000 PSI. Thus, the pump valve exceeds the requirement. Still, at the time, perhaps such a pump valve was on the only timely or costly solution to the requirement even if it was over-engineered.

The satisfaction level of a candidate physical component for component object 260 can take on many different forms. The satisfaction level of the physical component might cover all requirements 280, partially satisfy some of requirements 280, fail to satisfy some of requirements 280, or fail to satisfy requirements 280 at all. Further, two different historical components might have overlapping satisfaction levels where a first of the historical component more closely aligns with requirements 280 while a second of the historical components has a different satisfaction level where the two historical component might have been used in two different historical projects. Thus, the first historical component could be considered a viable alternative, yet might provide greater optimization of one or more project metrics relative to the candidate physical component.

Project metrics 270 reflect a possible measurement indicating performance or impact of an aspect of the capital project. Project metrics 270 also cover quite a broad spectrum. Project metrics 270 can scale from fine granularity at a component level up to coarse grained metrics at the project level. For example, a component level metric could include component inspection time while a project level metric could include cost of maintaining a supply chain through the life time of the project. Project metrics 270 can also be classified according to project phases or stages (e.g., proposal, engineering, design, construction, hand over, operation, management, end of life, etc.), type of metric (e.g., costs, time, personnel, maintenance, etc.), or other categorization.

One should appreciate component objects 260 are considered a primitive that represents an initial component definition outlining required features of a physical real-world component to be integrated into the optimization tool's design. In some embodiments, the design engineer might be required to instantiate a new physical real-world component that is not yet in a historical component database, and might further be optimal. In such a scenario, the design engineer can submit the component object 260 representing the real-world component to the historical component database.

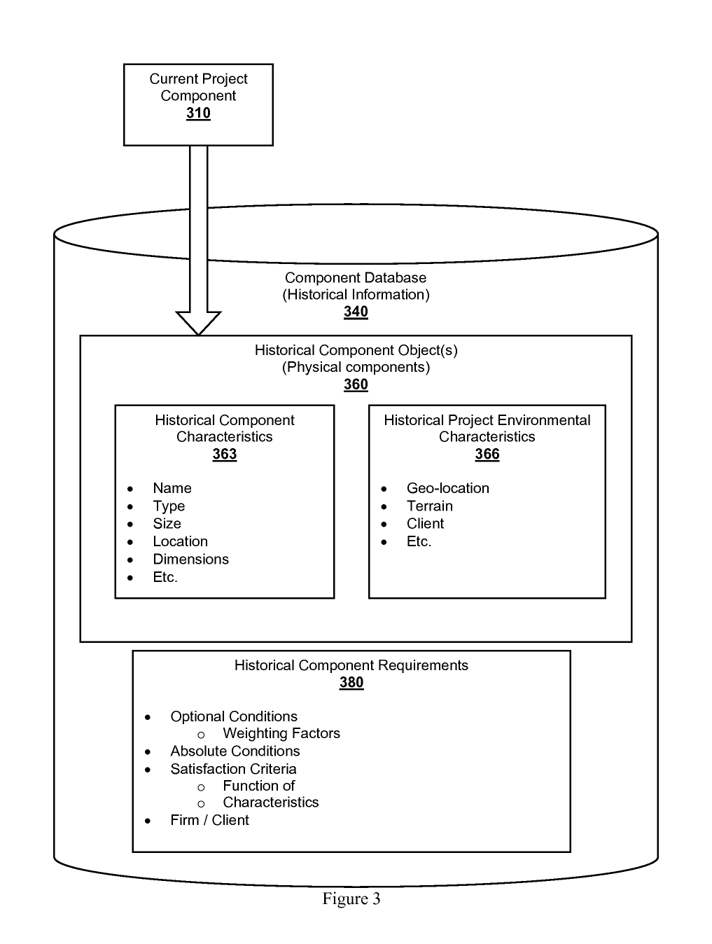

FIG. 3 presents an overview of component database 340 storing one or more historical component objects 360. Component database 340 can be considered a library of physical components actually deployed in historical projects where the physical components can be stored as manageable data objects (e.g., XML data structures). One should appreciate historical component objects 360 can also comprise assemblies of sub-component physical objects. Thus, a single historical component object 360 can be considered a system of historical component objects 360. Accordingly, historical component object 360 can also comprise differing levels of granularity from a smallest physical unit (e.g., a pipe, a bolt, a beam, etc.) up through modular processing block, or even to an over arching system. Component database 340 can be populated as current project components 310 take on actual real-world characteristics. For example, when an engineer assigns an actual real-world physical component to current project component 310, current project component 310 can be considered to become a historical component object 360.

Historical component database 340 is similar to the project database or can even be the same database. Example information stored in component database 340 includes historical component objects 360, historical environmental characteristics 366, historical component characteristics 363, or historical component requirements 380, or other real-world historical information. For example, historical component requirements 380 could include project firm requirements, project client requirements, project jurisdiction requirements, or other types of requirements that can define a context of the project. The optimization engine utilizes the historical component database 340 to search for instances of physical components that would be suitable in the context of the current capital project. When a historical physical component represented by historical component object 360 is found to be similar with respect to the characteristics (e.g., component characteristics, environmental characteristics, context, etc.) and appears to be over-engineered, then historical component object 360 can become a pivot point of analysis to discover possibly alternatives that are more optimal with respect to one or more project metrics

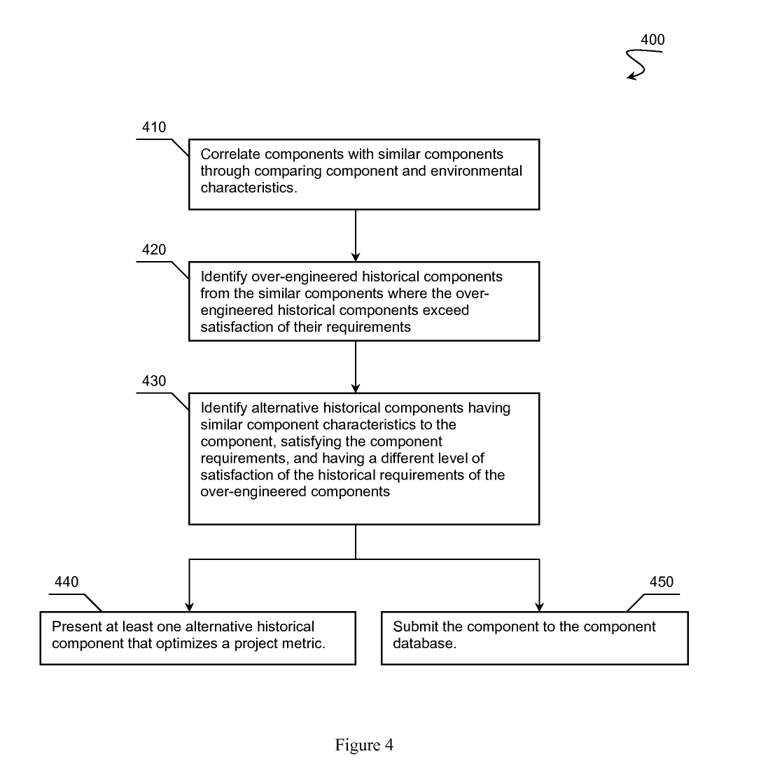

FIG. 4 outlines a possible method of identifying instances of over-engineering. As an engineer interacts with the optimization tool or environment, an optimization engine can review current component objects in real-time. One should appreciate the current component object does not necessarily reflect an actual instance of a construction component. Rather, the current component object can be considered a place holder or component primitive that is to be fleshed out according to a physical component to satisfy the current component object's design requirements. The optimization engine seeks to identify historical component objects reflecting actual instances of real-world objects that have been used in similar circumstances or contexts in the past.

The optimization engine is preferably configured to analyze requirements or context of a current component object to determine if historical component objects would be suitable for use in the current capital project. A step 410, the optimization engine correlates a current component object as a component object primitive with similar historical components. The optimization can correlate the objects through one or more techniques. In more preferred embodiments, the engine compares component characteristics and environment characteristics of the current component object with the corresponding characteristics of the historical component to determine if the two types of components have overlapping characteristics. If the two types of components have signification overlap, to within defined criteria, they can be considered similar.

In some embodiments, the optimization engine can also include an inference engine. The inference engine can be configured to identify correlations among various characteristics and project metrics; current or historical, on a contextual basis. The inference engine can apply one or more AI techniques to analyze the data to establish such correlations. Example techniques can include multi-variate analysis, simulated annealing, genetic algorithms, or other techniques. Such an approach allows the optimizing engine to create a discovery event for an engineer where an unexpected historical component might be applicable to a current component circumstance. Consequently, the engineer receives recommendations that they would ordinarily not consider. As an example, the inference engine can discover that, in some contexts, a pump might be suitable for a valve.

When similar historical components are found to be used in similar environments, the engine can identify if the similar historical components represent over-engineered solutions relative their historical requirements at step 420. An over-engineered component can be considered a component that exceeds one or more of the historical requirements (e.g., criteria, optional conditions, etc.). One should note the optimization engine does not require an exact match between the current component object and the similar historical components. Rather the two can be considered similar if they both satisfy correlation criteria or have similar contexts.

The optimization engine can apply one or more techniques to determine if the historical component represents an over-engineered component. In some embodiments, the optimization engine calculates a satisfaction level score by comparing the historical component's actual parameters against the applicable historical requirements. The score can be single valued or multi-valued. A single valued score can be calculated by converting the requirements or parameters to a numerical scale and applying one or more formulas to calculate a resulting satisfaction score. For example, a formula can weight optional conditions as desired, or weight over (or under) satisfaction by the extent that a parameter exceeds a requirement. Multi-valued satisfaction scores take into a consideration that a component's parameters or requirements can represent different aspects of a construction component. For example, a valve could have a pressure requirement and a flow requirement. A multi-value satisfaction score could reflect satisfaction with respect to both a pressure dimension and a flow dimension. Thus, a multi-valued satisfaction score can be considered to represent a multi-dimensional satisfaction space or extent within the requirement space.

At step 430, the engine can further review the historical information to identify one or more alternative components that would have also satisfied the historical requirements to a different degree than the similar historical component for the same historical requirements. The search pivots about the over-engineer component rather than the component object. The alternative components could come from the component database or even from the project database. Preferably the alternative component satisfies the historical requirements to a different level of satisfaction while also having a more optimized estimated impact one or more project metrics relative to the similar historical component.

Consider a scenario where an engineer is working on a pumping processing unit for a geographically wet location. The engine determines that a similar pumping unit has been used in a similar processing plant in the past in a wet location, but was over-engineered. The engine further finds an alternative pumping unit that has less maintenance, but still satisfies the requirements of the historical setting, at least to some degree, as well as the current requirements. The alternative pumping unit represents a more suitable solution with respect to maintenance and is still an expedient drop-in solution.

One should appreciate the alternative components can have a different level of satisfaction relative to historical components where the different level of satisfaction could be a great level of satisfaction (i.e., even more over-engineered) or lesser level of satisfaction (e.g., less over-engineered). Further, the alternative components can also have different levels of estimated impact on one or more project metrics. It is noted that in some scenarios, one might wish to incorporate an alternative component having a greater level of satisfaction, which might be a more desirable component in view of an impact on the project metrics.

At step 440, the optimization engine can present one or more alterative components, possibly presented according a ranking, to the engineers for possible integration into the current project. For example, the alternative components can be presented according to a ranking determined by their estimated impact on one or more project metrics, level of satisfaction of current or historical requirements, or other ranking If selected, an alterative component can be incorporated into the current capital project design by updating the current component object to take on the parameters of the alternative component. Thus, the current component object would become an instantiation of a physical real-world component.

At step 450, the optimization engine can be configured to submit a current component object having real-world values (e.g., component characteristics, environmental characteristics, etc.) under consideration back to the component database for use in future projects. When storing the current component, the engine can also submit the component's associated characteristics, environmental characteristics, requirements, contexts, or other information to the database. Further, the newly stored component information can be used to update or otherwise modify an existing historical component. For example, a historical component can be stored as revisable objects where each update includes revisions to a base object. Modifying a historical component can include changing values, storing a revision, fleshing out a template, or other forms of changing a component.

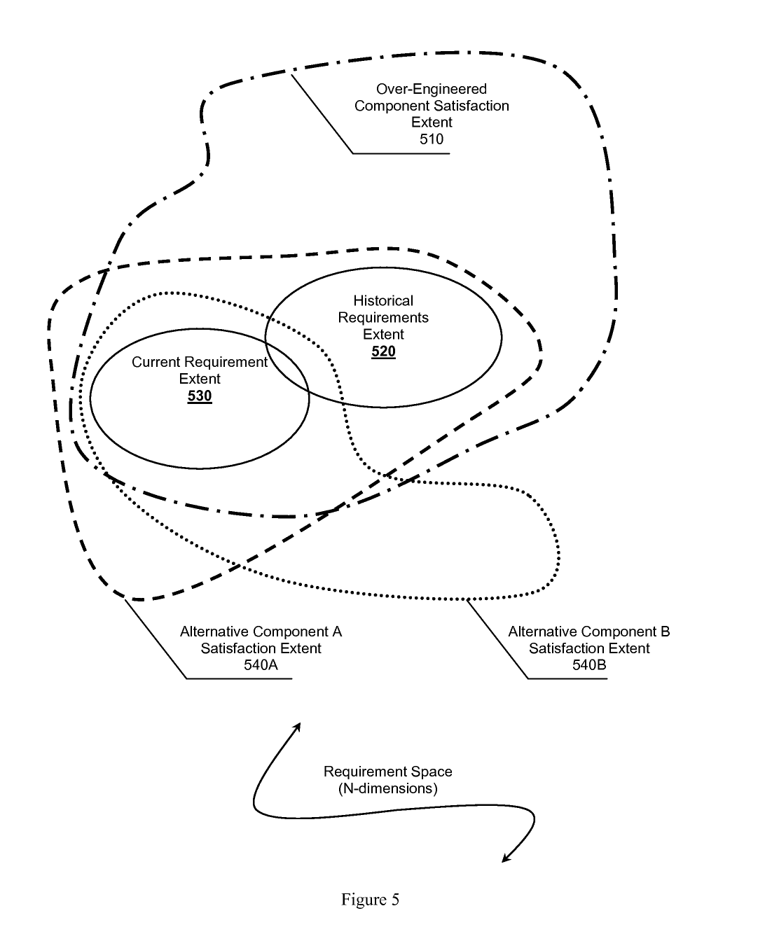

FIG. 5 presents a qualitative diagram illustrating the extent of a component's satisfaction of a set of requirements. The inventive subject matter is considered to include subtle points, thus a brief and more detailed discussion regarding satisfaction levels might be warranted.

The overall space in FIG. 5 can be considered a multi-dimensional requirement space represented as a two dimensional space. The solid ellipses illustrate a current requirement extent 530 within the requirement space and associated with component requirements in a current capital project, and a historical requirement extent 520 within the space associated with historical component requirements in a historical project. The broken curves illustrate satisfaction extents of actual real-world physical components used in historical projects.

A design engineer seeks possible components that have a satisfaction extent covering current component requirement extent 530. Based on component input including component requirement extent 530, an optimization engine searches for historical components that would be suitable for use based on similarities between a current component object and known historical component objects. In the example, the engine identifies an over-engineered component having satisfaction 510 where the over-engineered component is considered similar to the current component object and might also satisfactorily cover current requirement extent 530. The over-engineered component is likely non-optimal due to the over satisfaction of extent 510 relative to current requirement extent 530 or even historical requirement extent 540 for which it was originally intended. The over-engineered component becomes a pivot point for further analysis and creates opportunity for discovering more optimal, similar components.

The optimization engine further explores the historical database for possible alternative components; components A or B for example. Although the over-engineered component could be practical solution to cover current requirement extent 530, the over-engineered component targeted historical requirement extent 520. Requirement extents 520 and 530 would likely be different as illustrated, perhaps with some over lap. Therefore, alternative historical components might exist that are less over-engineered while optimizing a project metric and while meeting current needs.

In the example shown, component A has a satisfaction extent 540A covering both requirement extents 520 and 530. Thus component 540A is a possible alterative even though it has a different level of satisfaction relative to the historical requirements extent 520. In the case of component 540A, the different level of satisfaction is less than over-engineered satisfaction extent 510, but still covers historical requirement extent 520 as well as current requirement extent 530. Further, component B, also a possible solution, partially satisfies historical requirement extent 520, but still covers current requirement extent 530, as indicated by satisfaction extent 540B. Thus, both component A and component B could be acceptable alternatives. Although components A and B have different satisfaction extents 540A and 540B, each component can have different impacts on project metrics of interest. The design engineer can then select which component A or B depending on the impact on project metrics.

By employing an optimization engine that seeks over-engineered components and pivoting analysis on the over-engineered component, a design engineer can discover possible alternative components that might not have been explored otherwise.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A capital project optimization tool comprising:
a project design interface configured to accept component input representative of a component within a capital project;
a project database storing project metrics, the component input as component and environmental characteristics, and component requirements associated with the capital project;
a component database storing historical component information as historical component characteristics, historical project environmental characteristics, and corresponding historical requirements; and
an optimization engine configure to:
correlate the component with similar historical components through comparing corresponding component characteristics and environmental characteristics;
identify an over-engineered historical component from the similar historical components where the over-engineered historical component exceeded satisfaction of its historical requirements;
identify alterative historical components from the component database having similar component characteristics to the over-engineered component, satisfying the component requirements, and having a different-level of satisfaction of the historical requirements of the over-engineered historical component; and
present, via the design interface, at least one of the alternative historical components, where the at least one of the alternative historical components optimizes at least one of the project metrics.

2. The tool of claim 1, wherein the at least one of the alternative historical components has a greater level of satisfaction of the historical requirements.

3. The tool of claim 1, wherein at least one of the component requirements and the historical component requirements comprise optional conditions.

4. The tool of claim 1, wherein the project design interface comprises a computer automated design tool.

5. The tool of claim 1, wherein the optimization engine is further configured to rank the at least one of the alternative historical components according to the project metrics.

6. The tool of claim 1, wherein the project metrics comprise at least one of the following types of metrics: cost metric, time metric, maintenance cost, inspection times or duration, ease of use, training metric, personnel metric, destruction or end-of-life metrics, and support level from a jurisdiction.

7. The tool of claim 1, wherein the historical component requirements comprises project firm requirements.

8. The tool of claim 1, wherein the historical component requirements comprises project client requirements.

9. The tool of claim 1, wherein the historical component requirements comprises project jurisdiction requirements.

10. The tool of claim 1, wherein the optimization engine is further configured to rank the component with the at least one of the alternative historical components relative to optimized project metrics.

11. The tool of claim 10, wherein the component is determined to comprise a more optimal component than at least some of the alternative historical components.

12. The tool of claim 1, wherein the optimization engine is further configured to submit the component to the component database as component information including the component's component characteristics and environmental characteristics.

13. The tool of claim 12, wherein the component information modifies an existing historical component.

14. The tool of claim 1, wherein the optimization engine comprises an inference engine configured to correlate the at least some of the component characteristics and environmental characteristics with the project metrics.

15. The tool of claim 1, wherein the project metrics comprise a desired final state of the project.

16. The tool of claim 15, wherein the optimization engine is further configured to recommend the at least one of the alterative historical components as more closely aligning with the desired final state determined from a backward chaining analysis.

17. The tool of claim 1, wherein the alternative component comprises a processing block module.

18. The tool of claim 15, wherein the processing block module has reduced level of satisfaction of the historical requirements.

19. The tool of claim 15, wherein the project metric comprises a modularization metric.

20. The tool of claim 1, wherein at least one of the project metrics comprises a prioritized set of metrics.

21. The tool of claim 18, wherein the prioritized set of metrics comprises at least two of the following metrics: a cost metric, a vendor metric, a space metric, and a client metric.
